(19) United States
(12) Patent Application Publication
(10) Pub. No.: US 2022/0253849 A1
(43) Pub. Date: Aug. 11, 2022

(54) ELECTRONIC APPARATUS FOR PROCESSING ITEM SALES INFORMATION AND METHOD THEREOF

(71) Applicant: Coupang Corp., Seoul (KR)

(72) Inventors: Bo Mi Choi, Seoul (KR); Ye Hwan Jeon, Seoul (KR); Jin Hwan Kim, Seoul (KR); Hyun Yong Jung, Seoul (KR); Young Kyo Jung, Seoul (KR); Ki Hyun Jeong, Seoul (KR); Il Hyun Seo, Seoul (KR)

(21) Appl. No.: 17/196,746

(22) Filed: Mar. 9, 2021

(30) Foreign Application Priority Data
Feb. 5, 2021 (KR) 10-2021-0016994

(51) Int. Cl. G06Q 20/40; G06Q 10/08

(52) U.S. Cl. CPC G06Q 20/407; G06Q 20/405; G06Q 20/401; G06Q 10/083

(57) ABSTRACT

Disclosed is a method of processing item sales information in an electronic apparatus, the method including receiving a transaction request for at least one item including a transaction method and transaction amount information, providing, when the transaction method is a specific type of transaction method and a time in which the transaction request is received is included in a time section or within a time period corresponding to the transaction method, a transaction response including approval information corresponding to the transaction request before payment information corresponding to the transaction request is received from a first server corresponding to the transaction method, transmitting a shipping request for at least a portion of the at least one item to a second server, and transmitting a payment request to the first server in response to the time section or the time period ending.

### BACKGROUND

### Technical Field

The present disclosure relates to an electronic apparatus for processing item sales information and a method thereof. More particularly, the present disclosure relates to an electronic apparatus that provides a transaction response including approval information corresponding to a transaction request before payment information corresponding to the transaction request is received from a first server when a time in which the transaction request is received is included in a time section or within a time period corresponding to a transaction method, transmits a shipping request for at least some items to a second server, and transmits a payment request to the first server in response to the time section ending, and a method thereof.

### Description of the Related Art

With the development of electronic technology, e-commerce has become a common type of shopping. A customer may purchase an item online without needing to go to a shopping mall or market in person, and the item purchased online is delivered to a delivery destination requested by the customer.

In terms of an e-commerce transaction, because the speed of item delivery has a significant impact on service satisfaction, various ways to deliver items to customers more quickly are being discussed. As one method for such rapid delivery, fulfillment centers are being provided in various regions. Each fulfillment center stores a variety of items sold online, and when an item is purchased, delivery is made to a customer who has purchased the item at a fulfillment center near the customer.

In the e-commerce transaction, transaction of an item may be made through a financial institution such as a bank. The financial institution such as a bank conducts periodic inspections to check the integrity of a system and also conducts the inspections for maintenance, repair, replacement, and upgrade of various computer networks. However, the transaction of the item for the e-commerce transaction may be restricted during maintenance hours. As the transaction of the item is restricted, preparation for delivery of the item may not be processed. As a result, when a transaction request of the item is received during maintenance hours corresponding to a transaction method, the delivery of the item may be delayed.

In connection, prior documents such as KR101756594B1 and KR101500849B1 may be referred.

### SUMMARY

### Technical Goals

An aspect provides an electronic apparatus that provides a transaction response including approval information corresponding to a transaction request before payment information corresponding to the transaction request is received from a first server when a time in which the transaction request is received is included in a time section or within a time period corresponding to a transaction method, transmits a shipping request for at least some items to a second server, and transmits a payment request to the first server in response to the time section ending, and a method thereof.

Technical goals to be achieved through the example embodiments are not limited to the technical goals as described above, and other technical tasks can be inferred from the following example embodiments.

### Technical Solutions

According to an aspect, there is provided a method of processing item sales information in an electronic apparatus, the method including receiving a transaction request for at least one item including a transaction method and transaction amount information, providing, when the transaction method is a specific type of transaction method and a time in which the transaction request is received is included in a time section corresponding to the transaction method, a transaction response including approval information corresponding to the transaction request before payment information corresponding to the transaction request is received from a first server corresponding to the transaction method, transmitting a shipping request for at least a portion of the at least one item to a second server, and transmitting a payment request to the first server in response to the time section ending.

The providing of the transaction response may include determining whether the at least one item is an item to be delivered, and providing, when at least a portion of the at least one item is the item to be delivered, the transaction response for an item to be delivered among the at least one item.

The method may further include providing, when at least a portion of the at least one item is a non-delivery item, transaction denial information responding to the transaction request for a non-delivery item among the at least one item. The transaction denial information may include information on the time section.

The transaction method may correspond to a transfer of a transaction amount based on an account managed by the first server. The payment request may correspond to a request for the first server to transfer the transaction amount based on the account and transmit payment information including transfer details of the transaction amount to the electronic apparatus.

Information associated with the account may be registered in the electronic apparatus in advance.

The method may further include canceling, when payment failure information is received from the first server in response to the payment request, approval corresponding to the transaction request and transmitting a cancellation request for the shipping request to the second server.

The method may further include transmitting, when payment failure information is received from the first server in response to the payment request and shipping for at least a portion of the at least one item is completed, a turn-in request for a shipping-completed item to a third server.

The method may further include receiving, from at least one server corresponding to at least one transaction method, at least one time section information corresponding to the at least one transaction method.

The time section may include a time for performing a system maintenance related to the first server. The system maintenance may be performed periodically.

The method may further include retransmitting the payment request to the first server when payment failure information is received from the first server in response to the payment request, and when the payment failure information includes information indicating that the time section has not ended yet.

The method may further include canceling, when a transaction cancellation request for the at least one item is received, approval corresponding to the transaction request and transmitting a cancellation request for the shipping request to the second server.

The cancellation request for the shipping request may be transmitted to the second server based on a time section for performing a shipping task corresponding to the shipping request.

When a time in which the transaction cancellation request is received is included in the time section, approval corresponding to the transaction request may be canceled in response to the time section ending.

The method may further include transmitting, when a time in which the transaction cancellation request is received is not included in the time section, a cancellation request for the payment request to the first server.

The method may further include storing sales information on the at least one item including identification information associated with the transaction method and canceling, when payment failure information is received from the first server, transaction for the sales information including the identification information. The canceling of the transaction may include canceling approval corresponding to the transaction request and transmitting a cancellation request for the shipping request to the second server.

According to another aspect, there is also provided an electronic apparatus for processing item sales information, the electronic apparatus including a transceiver, a memory in which instructions are stored, and a processor, wherein the processor is connected to the transceiver and the memory to receive a transaction request for at least one item including a transaction method and transaction amount information, provide, when the transaction method is a specific type of transaction method and a time in which the transaction request is received is included in a time section corresponding to the transaction method, a transaction response including approval information corresponding to the transaction request before payment information corresponding to the transaction request is received from a first server corresponding to the transaction method, transmit a shipping request for at least a portion of the at least one item to a second server, and transmit a payment request to the first server in response to the time section ending.

Details of example embodiments are included in the detailed description and drawings.

### Effects

According to an aspect of the present disclosure, when selling an item in an e-commerce market, an electronic apparatus for processing item sales information and a method thereof may provide approval information corresponding to a transaction request before a time section or a time period (for example, bank maintenance hours) corresponding to a transaction method ends and transmit a shipping request so that the item is quickly delivered irrespective of the time section corresponding to the transaction method.

According to another aspect of the present disclosure, an electronic apparatus for processing item sales information and a method thereof may transmit a payment request to a server corresponding to a transaction method at a time that a time section ends. Regarding this, in example embodiments of the present disclosure, transaction approval and shipment may be canceled when an electronic apparatus receives payment failure information from a server. Accordingly, it is possible to prevent a situation in which transaction of an item is approved and the item is shipped and delivered although a transaction amount of the item is not paid.

Effects are not limited to the aforementioned effects, and other effects not mentioned will be clearly understood by those skilled in the art from the description of the claims.

### BRIEF DESCRIPTION OF THE DRAWINGS

FIG. 1 is a diagram illustrating an item sales information processing system according to an example embodiment.

FIG. 2 is a flowchart illustrating an information processing method performed by an item sales information processing system according to an example embodiment.

FIG. 3 is a flowchart illustrating a method of determining whether an item is a target on which an information processing method is to be performed by an electronic apparatus in an item sales information processing system according to an example embodiment.

FIG. 4 is a flowchart illustrating an operation performed in a case in which payment failure information is received by an electronic apparatus in an item sales information processing system according to an example embodiment.

FIG. 5 is a flowchart illustrating an operation performed in which a transaction cancellation request is received by an electronic apparatus in an item sales information processing system according to an example embodiment.

FIG. 6 is a diagram illustrating an example of a transaction method used in an item sales information processing system according to an example embodiment.

FIG. 7 is a flowchart illustrating a method of processing item sales information by an electronic apparatus according to an example embodiment.

FIG. 8 is a diagram illustrating an example of a configuration of an electronic apparatus for processing item sales information according to an example embodiment.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

The expression “at least one of A, B, and C” may include the following meanings: A alone; B alone; C alone; both A and B together; both A and C together; both B and C together; and all three of A, B, and C together.

In the present disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described with reference to the drawings.

In describing the example embodiments, descriptions of technical contents that are well known in the art to which the present disclosure belongs and are not directly related to the present specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

At this point, it will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

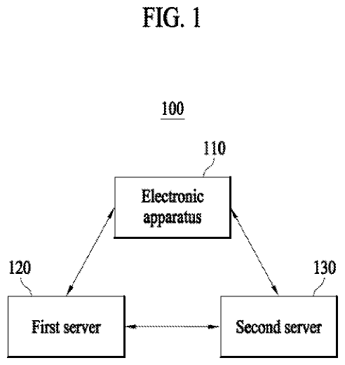

FIG. 1 is a diagram illustrating an item sales information processing system according to an example embodiment.

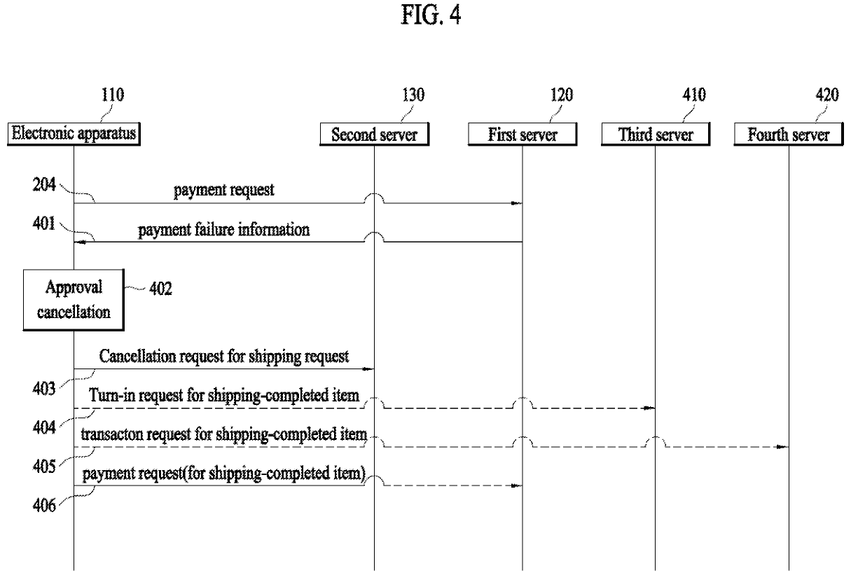

According to various example embodiments, an item sales information processing system 100 may include an electronic apparatus 110, a first server 120, and a second server 130. Although not shown, in an example embodiment, the item sales information processing system 100 may further include at least one of a third server (e.g., a third server 410 of FIG. 4) and a fourth server (a fourth server 420 of FIG. 4). Although not shown, in an example embodiment, the item sales information processing system 100 may further include a network that supports data transmission and reception performed between at least some of the electronic apparatus 110, the first server 120, the second server 130, the third server 410, and the fourth server 420.

Each of the electronic apparatus 110, the first server 120, the second server 130, the third server 410, and the fourth server 420 may include a transceiver, a memory, and a processor. In addition, each of the electronic apparatus 110, the first server 120, the second server 130, the third server 410, and the fourth server 420 may be a unit that processes at least one function or operation, which may be implemented by hardware or software, or a combination of hardware and software. Meanwhile, in the overall example embodiments, the electronic apparatus 110, the first server 120, and the second server 130 are referred to as separate devices or servers, but these may be logically divided structures and implemented as separate functions in a single server.

According to an example embodiment, the electronic apparatus 110, the first server 120, the second server 130, the third server 410, and the fourth server 420 may include a plurality of computer systems implemented as network servers or computer software. For example, at least some of the electronic apparatus 110, the first server 120, the second server 130, the third server 410, and the fourth server 420 may refer to a computer system and computer software connected to a lower level device capable of communicating with another network server through a computer network such as an intranet or the Internet to receives a request to perform a task, performs the task, and provides a result of the task. In addition, at least some of the electronic apparatus 110, the first server 120, the second server 130, the third server 410, and the fourth server 420 may be understood as broad concepts including a series of application programs that can operate on a network server and various databases built therein. At least some of the electronic apparatus 110, the first server 120, the second server 130, the third server 410, and the fourth server 420 may be implemented using a network server program that is provided in various ways based on an operating system such as DOS, Windows, Linux, UNIX, or MacOS, for example.

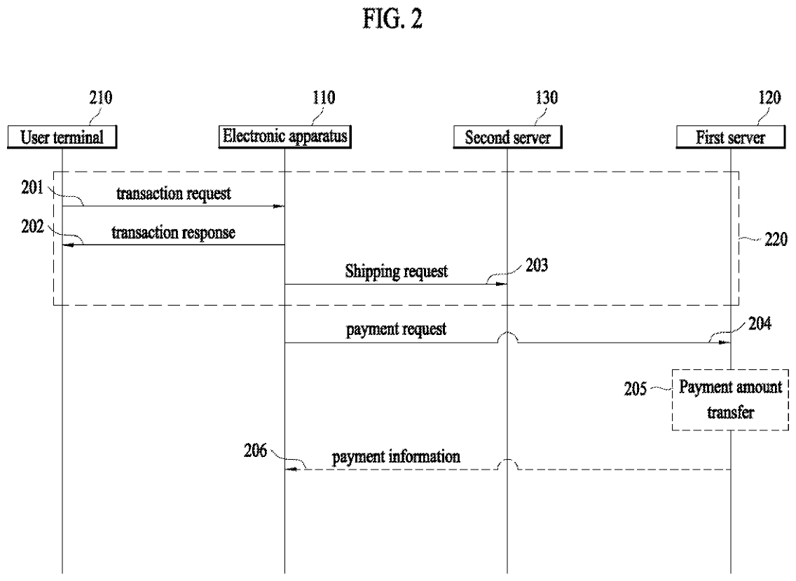

The electronic apparatus 110 may provide various information by configuring the information into a web page. Specifically, the electronic apparatus 110 may be a device that serves to provide item sales information to a user. To provide the information, the electronic apparatus 110 receives a transaction request for at least one item including a transaction method and transaction amount information. At least one item may be an item displayed by the electronic apparatus 110, which is an item to be purchased online by a user (or customer) through the electronic apparatus 110. The transaction request for the at least one item may be received from a user terminal (e.g., a user terminal 210 of FIG. 2).

When the transaction method is a specific type of transaction method and a time in which the transaction request is received is included in a time section or within a time period corresponding to the transaction method, the electronic apparatus 110 may provide a transaction response including approval information corresponding to the transaction request before payment information corresponding to the transaction request is received from the first server 120 corresponding to the transaction method. The specific type of transaction method may correspond to a transfer of a transaction amount based on an account managed by the first server 120. For example, the specific type of transaction method may correspond to an account transfer based on an XX bank account. In this example, payment information corresponding to a request may correspond to information indicating that a transaction amount is transferred based on the account managed by the first server 120. Meanwhile, the description of the account transfer in the overall example embodiments may include a method in which a user registers transaction account information, so that the electronic apparatus 110 performs transaction based on a registered account to which a payment request is sent according to the payment.

In an example embodiment, the electronic apparatus 110 may receive at least one time section information corresponding to at least one transaction method from at least one server corresponding to the at least one transaction method in advance. Based on the received time section information, the electronic apparatus 110 may determine whether the time in which the transaction request is received in association with the specific type of transaction method is included in the time section corresponding to the transaction method. In the example embodiment, the time section corresponding to the transaction method may include a time section in which payment related to the corresponding transaction method is temporarily suspended at the corresponding time. The time section may be set for each transaction method, and the set information may be acquired and managed by the electronic apparatus 110.

In an example embodiment, account information associated with the account managed by the first server 120 may be received along with the transaction request. Also, account information associated with the account managed by the first server 120 may be registered in the electronic apparatus 110 in advance. When the information associated with the account is registered in the electronic apparatus 110 in advance, the electronic apparatus 110 may perform the transaction using the registered account information without needing to receive account information from the user.

In addition to the information associated with the account, the user may register a password for transaction, user's fingerprint information, or user's facial information in the electronic apparatus 110 in advance. In this case, when performing the transaction using the account, the user may enter the password for transaction, scan the fingerprint of the user, or scan the face of the user, thereby performing the transaction. In this case, the transaction request may include at least one of the received password for transaction, fingerprint recognition information of the user, or facial recognition information of the user. Accordingly, the user does not need to input the account information and does not need to perform an identity authentication procedure using a portable terminal or accredited certificate, so that the convenience of transaction is improved.

The time section corresponding to the transaction method may include a time in which an operation of the first server 120 is suspended or a time in which a normal operation of the first server 120 is restricted. According to an example embodiment, the time section corresponding to the transaction method may include a time in which a system maintenance related to the first server 120 is performed. In this case, the system maintenance may include a periodically performed system maintenance and an aperiodically performed system maintenance.

The transaction response including the approval information corresponding to the transaction request may be information indicating that the transaction has been successfully performed on at least a portion of the at least one item.

The electronic apparatus 110 transmits the shipping request for at least a portion of the at least one item to the second server 130 and transmits a payment request to the first server 120 in response to the time section ending. The shipping request may correspond to a request to unstock at least some of items from a fulfillment center and arrange for delivery. The payment request may correspond to a request to pay a transaction amount for at least some of the items. Specifically, the payment request may correspond to a request for the first server 120 to transfer a transaction amount based on the account and transmit payment information including transfer details of the transaction amount to the electronic apparatus 110.

In response to the shipping request being transmitted, preparation for delivery for at least some of the items requested by the user for transaction may be initiated. By transmitting the payment request to the first server 120 in response to the time section ending, the transaction may be actually made for at least some of the items at the end of the time section. The payment request may include account information. When the account information is registered in advance, the registered account information may be transmitted.

The first server 120 may be a server corresponding to a specific type of transaction method. Specifically, the specific type of transaction method may correspond to a transfer of the transaction amount based on the account managed by the first server 120. According to an example embodiment, the first server 120 may correspond to a server managed by a specific financial institution. For example, the first server 120 may correspond to a server managed by an XX bank. When the payment request is received from the electronic apparatus 110, the first server 120 may determine whether the account information included in the payment request is valid and determine whether a balance of the account corresponding to the account information is greater than or equal to an amount for the payment request. Based on a determination result, the first server 120 may transfer the transaction amount to the electronic apparatus 110 or transmit payment failure information to the electronic apparatus 110. A description of such will be given in greater detail with reference to FIGS. 2 and 4.

The second server 130 may be a server managed in a fulfillment center for storage and delivery of items being sold online through the electronic apparatus 110. When the shipping request for at least a portion of at least one item is received, the second server 130 may process a shipment of an item and deliver the shipping-completed item to an address received as an input. When a cancellation request for the shipping request is received for an item for which delivery has not started yet, the second server 130 may cancel the shipment.

The third server 410 may correspond to a server that processes turning-in of an item that has been already shipped but the cancellation request for the shipping request is received. The fourth server 420 may be a server corresponding to a transaction method different from the transaction method corresponding to the first server 120.

The third server 410 and the fourth server 420 will be further described in greater detail with reference to FIG. 4.

A series of operations related to a method for processing item sales information according to various example embodiments may be implemented by a single physical device, or may be implemented by a plurality of physical devices combined organically. For example, some of the components included in the item sales information processing system 100 may be implemented by any one physical device, and the remaining components may be implemented as another physical device. For example, one physical device may be implemented as a part of the electronic apparatus 110, and another physical device may be implemented as a part of the first server 120, a part of the second server 130, a part of the third server 410, a part of the fourth server 420, or a part of an external device. In some cases, components included in the item sales information processing system may be distributed and arranged in different physical devices. The distributed components may be organically combined to perform functions and operations of the item sales information processing system 100. For example, the electronic apparatus 110 of the present disclosure may include at least one sub-device. Some operations described as being performed by the electronic apparatus 110 may be performed by a first sub-device, and some other operations may be performed by a second sub-device.

FIG. 2 is a flowchart illustrating an information processing method performed by an item sales information processing system according to an example embodiment.

Referring to FIG. 2, the electronic apparatus 110 according to an example embodiment receives a transaction request for at least one item from a user terminal 210 in operation 201. The user terminal 210 may include, for example, a computer device, a mobile communication terminal, or the like. When a transaction method is a specific type of transaction method (e.g., the transaction method corresponding to the first server 120) and a time in which the transaction request is received is included in a time section 220 corresponding to the transaction method, in operation 202, the electronic apparatus 110 provides a transaction response including approval information corresponding to the transaction request before payment information corresponding to the transaction request is received from the first server 120 corresponding to the transaction method in operation 206. In operation 203, the electronic apparatus 110 transmits a shipping request for at least a portion of the at least one item to the second server 130.

The electronic apparatus 110 transmits a payment request 204 to the first server 120 in response to the time section 220 ending. For example, the electronic apparatus 110 may transmit the payment request 204 at an expected end time of the time section 220. In addition, the electronic apparatus 110 may transmit the payment request 204 after a preset period of time elapses from the expected end time of the time section 220 in consideration of an error of the time section 220. Also, the electronic apparatus 110 may transmit the payment request 204 after information indicating that the time section 220 ends is received from the first server 120.

When the payment request is received, the first server 120 may determine whether the account information included in the payment request is valid and determine whether a balance of an account corresponding to the account information is greater than or equal to an amount for the payment request. When the account information included in the payment request is valid, and when a balance of an account corresponding to the account information is greater than or equal to an amount for the payment request, the first server 120 may transfer the transaction amount to the electronic apparatus 110 in operation 205 and transmit payment information including transfer details to the electronic apparatus 110 in operation 206. In the example embodiment, the transfer may include at least one of transaction occurring in response to the electronic apparatus 110 sending a payment request for a specific amount to the first server 120 and transaction in which the first server 120 is triggered such that a requested amount is paid.

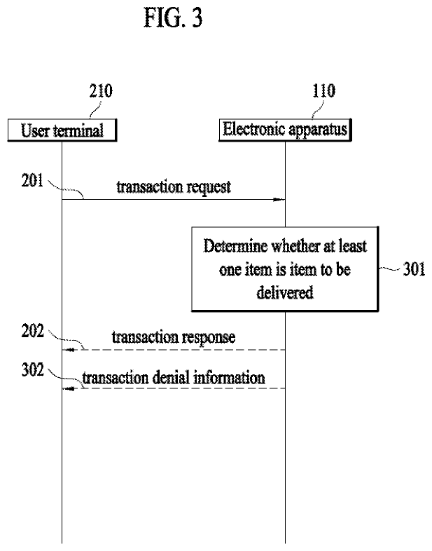

FIG. 3 is a flowchart illustrating a method of determining whether an item is a target on which an information processing method is to be performed by an electronic apparatus in an item sales information processing system according to an example embodiment.

Referring to FIG. 3, the electronic apparatus 110 according to an example embodiment receives a transaction request for at least one item from the user terminal 210 in operation 201 and determines whether the at least one item is an item to be delivered in operation 301. The item to be delivered may indicate an item shipped from a fulfillment center and delivered to an address of a user. A non-delivery item may correspond to an item that is not to be delivered, such as digital products, various insurance products, and intangible services.

When at least a portion of the at least one item is an item to be delivered, in operation 202, the electronic apparatus 110 may provide a transaction response for the item to be delivered. When at least a portion of the at least one item is a non-delivery item, in operation 302, the electronic apparatus 110 may provide transaction denial information responding to the transaction request for the non-delivery item. In this case, the transaction denial information may include information on the time section 220 or time period 220. For example, when the time section 220 is a period from 00:10 am to 00:35 am, and when the electronic apparatus 110 receives a transaction request related to a digital product corresponding to a non-delivery item at 00:20 am, the electronic apparatus 110 may provide transaction denial information including information indicating that the time section 220 is a period from 00:10 am to 00:35 am to the user terminal 210.

In some cases, the electronic apparatus 110 may calculate a remaining time from a reception time of the transaction request to an end of the time section 220 and provide the calculated remaining time to the user terminal 210. For example, when the time section 220 is a period from 00:10 am to 00:35 am, and when the electronic apparatus 110 receives a transaction request related to a digital product corresponding to a non-delivered target at 00:20 am, the electronic apparatus 110 may additionally provide information indicating that 15 minutes remain to the end of the time section 220 to the user terminal 210.

FIG. 4 is a flowchart illustrating an operation performed in a case in which payment failure information is received by an electronic apparatus in an item sales information processing system according to an example embodiment.

Referring to FIG. 4, the electronic apparatus 110 according to an example embodiment transmits the payment request 204 to the first server 120 in response to the time section 220 ending. When the payment request is received, the first server 120 may determine whether account information included in the payment request is valid and determine whether a balance of an account corresponding to the account information is greater than or equal to an amount requested to be paid. When the account information included in the payment request is invalid, or when the balance of the account corresponding to the account information is less than the amount requested to be paid, in operation 401, the first server 120 may transmit payment failure information indicating that payment fails to the electronic apparatus 110. In addition, when it is impossible to pay a transaction amount through an account corresponding to a payment request due to various reasons (for example, when the time section 220 is extended, when a new time period has started, or when a transfer function of the account has been shut, etc.), the first server 120 may transmit payment failure information indicating that payment fails to the electronic apparatus 110 in operation 401.

In response to the payment failure information being received, the electronic apparatus 110 may cancel approval corresponding to the transaction request in operation 402 and transmit a cancellation request for a shipping request to the second server 130 in operation 403. If the item is not shipped yet, the second server 130 may cancel shipping the item. In some cases, even if the shipping of the item has started but delivery of the item is not started yet, the second server 130 may cancel the shipment and delivery of the item. Hereinafter, for ease and convenience, a description is given of a case in which the second server 130 cancels shipping an item if the item is not shipped yet and requests the item to be turned in or a user to pay an amount for the item if at least a portion of the item has been shipped already.

When at least a portion of the item has been shipped already, the electronic apparatus 110 may request the item to be turned in or a user to pay an amount for the item. Specifically, the electronic apparatus 110 may transmit a turn-in request for a shipping-completed item to the third server 410 in operation 404, transmit a transaction request for a shipping-completed item to the fourth server 420 corresponding to a transaction method different from the transaction method corresponding to the first server 120 in operation 405, or transmit a payment request to the first server 120 in operation 406. In this case, the payment request transmitted to the first server 120 may be transmitted for a shipping-completed item or also be transmitted to an item for which a shipment is not completed yet. In a case in which the payment request is also be transmitted to an item for which a shipment is not completed yet, the transmitted payment request may be the same payment request as the payment request that has been transmitted to the first server 120 in response to the time section 220 ending.

According to an example embodiment, in response to the payment failure information being received from the first server 120, the electronic apparatus 110 may retransmit the payment request before canceling the approval corresponding to the transaction request. Specifically, when the payment failure information received from the first server 120 includes information indicating that a time section has not ended yet, the electronic apparatus 110 may retransmit the payment request to the first server 120. For example, due to an extension of a time section caused by circumstances of a financial institution corresponding to the first server 120, the electronic apparatus 110 may transmit the payment request before the time section ends and receive the payment failure information. In this example, the electronic apparatus 110 may retransmit the payment request.

According to an example embodiment, the payment failure information may include a response code corresponding to a time section that has not ended. In addition, according to an example embodiment, the electronic apparatus 110 may retransmit a payment request to the first server 120 a plurality of times. Meanwhile, according to an example embodiment, the electronic apparatus 110 may assign a separate identifier to sales information for which the transaction response is provided, the shipping request is sent, and payment is not completed so as to manage the sales information. Thereafter, when transaction by the transaction method corresponding to the first server 120 is unavailable, such as receiving the payment failure information from the first server 120, a collective sale cancellation may be processed by canceling approval corresponding to the transaction request for the sales information to which the identifier is assigned and transmitting a cancellation request for the shipping request to the second server 130.

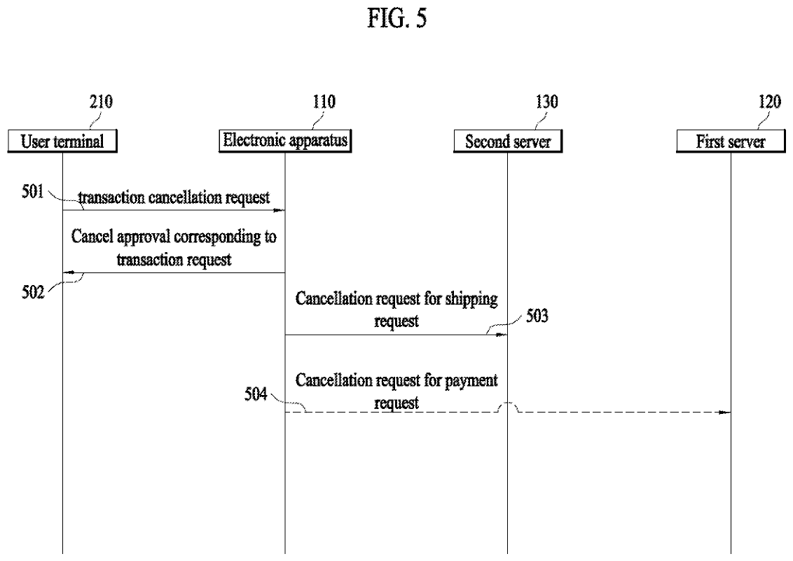

FIG. 5 is a flowchart illustrating an operation performed in which a transaction cancellation request is received by an electronic apparatus in an item sales information processing system according to an example embodiment.

Referring to FIG. 5, in operation 501, a user may transmit a transaction cancellation request for at least one item through the user terminal 210. In response to the transaction cancellation request being received, the electronic apparatus 110 may cancel approval corresponding to a transaction request in operation 502 and transmit a cancellation request for a shipping request to the second server 130 in operation 503.

According to an example embodiment, when a time in which the transaction cancellation request is received is included in the time section 220 or within the time period 220, in operation 502, the electronic apparatus 110 may cancel the approval corresponding to the transaction request after transmitting the payment request to the first server 120 in response to the time section ending, and then may further transmit a cancellation request for the payment request to the first server 120. In some cases, when a time in which the transaction cancellation request is received is included in the time section 220, the electronic apparatus 110 may disallow the payment request to be transmitted to the first server 120. In such cases, since the payment request is not transmitted to the first server 120 yet, transmission of a separate payment request may be omitted.

When a time in which the transaction cancellation request is received is not included in the time section 220, in operation 504, the electronic apparatus 110 may transmit a cancellation request for the transmitted payment request to the first server 120.

According to an example embodiment, the electronic apparatus 110 may transmit the cancellation request for the shipping request to the second server 130 based on a time section for performing a shipping task corresponding to the shipping request. The time section for performing the shipping task may include a period of time for which the shipping task can be normally performed in a fulfillment center managing the second server 130. For example, a period from 3:00 am to 4:00 am may correspond to a worker's break time set in the fulfillment center and thus, a shipment may not be carried out for this period. In this example, a time section for performing the shipping task may be a period from 4:00 am to 3:00 am the next day.

For example, when the time section for performing the shipping task is a period from 4:00 am to 3:00 am the next day, and when the electronic apparatus 110 receives a transaction cancellation request for at least one item at 3:20 am, the electronic apparatus 110 may transmit a cancellation request for a shipping request to the second server 130 at 4:00 am that is a time when the time section for performing the shipping task starts.

Further, according to an example embodiment, the electronic apparatus 110 may provide information indicating a time section for performing a shipping task to the user terminal 210. In some cases, the electronic apparatus 110 may calculate a remaining time from a reception time of the transaction cancellation request to a start of the time section for performing the shipping task and provide the calculated remaining time to the user terminal 210. For example, when the time section for performing the shipping task is the period from 4:00 am to 3:00 am the next day, and when the electronic apparatus 110 receives the transaction cancellation request for at least one item at 3:20 am, the electronic apparatus 110 may additionally provide information indicating that 40 minutes remain to the start of the time section for performing the shipping task to the user terminal 210.

When at least a portion of the item has been shipped already, the electronic apparatus 110 may request the item to be turned in or a user to pay an amount for the item. Specifically, the electronic apparatus 110 may transmit a turn-in request for a shipping-completed item to the third server 410, transmit a transaction request for a shipping-completed item to the fourth server 420 corresponding to a transaction method different from the transaction method corresponding to the first server 120, or transmit a payment request to the first server 120. Related detailed content may correspond to the description of FIG. 4.

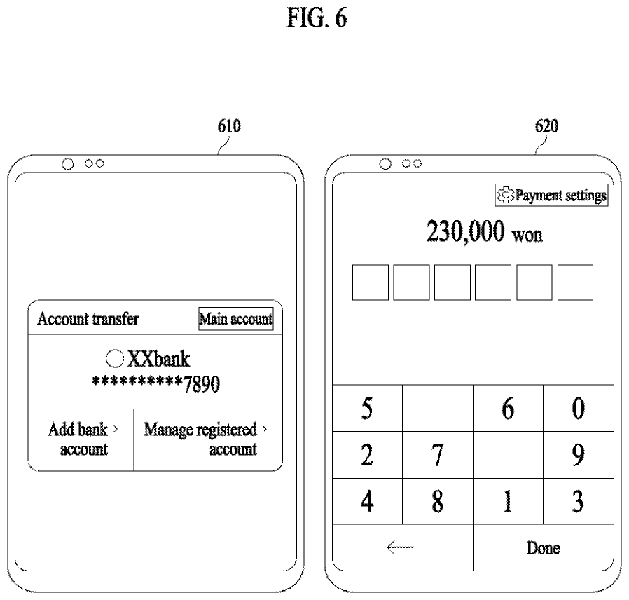

FIG. 6 is a diagram illustrating an example of a transaction method used in an item sales information processing system according to an example embodiment.

Referring to FIG. 6, in an item sales information processing system according to an example embodiment, a transaction method may correspond to a transfer of a transaction amount based on an account managed by a corresponding server. Specifically, the transaction method may correspond to a transfer of a transaction amount performed using an account managed by a specific financial institution (for example, XX bank) and held by a user. The electronic apparatus 110 may receive account information and the transaction request from the user terminal 210 or use account information registered by the user in advance.

Reference numeral 610 shows an example of registering account information in advance. Specifically, the user may input the account information through the user terminal 210 in advance before the transaction request is made. In this case, the user may previously input at least a portion of information required to perform an account transfer online, thereby achieving the convenience of transaction. The user may input at least some of, for example, a financial institution managing the account, account numbers, an account holder, and a password for the account.

Reference numeral 620 shows an example of an identity authentication related to account information registered in advance. Specifically, the user may perform an identity authentication procedure using a portable terminal or an accredited certificate, along with the account information and store an authentication result in the electronic apparatus 110. Thereafter, when transmitting a transaction request for at least one item using the registered account information, the user does not need to perform the identity authentication procedure using the portable terminal or the accredited certificate. In this case, to improve security, the user may previously register, in the electronic apparatus 110, a password for transaction, user's fingerprint information, or user's facial information along with information associated with the account and an identity authentication result. Accordingly, the user may conveniently perform the identity authentication by entering the password for transaction, scanning a fingerprint of the user, or scanning a face of the user without needing to perform the identity authentication using the portable terminal or the accredited certificate. Through this, the transaction request using the account information input in advance may be transmitted to the electronic apparatus 110.

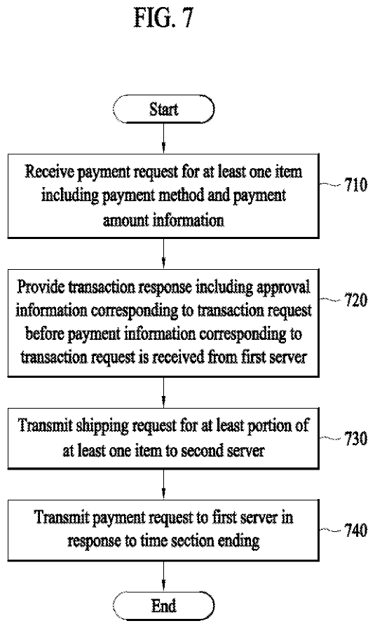

FIG. 7 is a flowchart illustrating a method of processing item sales information by an electronic apparatus according to an example embodiment.

Referring to FIG. 7, the electronic apparatus 110 according to an example embodiment receives a transaction request for at least one item including a transaction method and transaction amount information in operation 710. When the transaction method is a specific type of transaction method and a time in which the transaction request is received is included in a time section or within a time period corresponding to the transaction method, in operation 720, the electronic apparatus 110 provides a transaction response including approval information corresponding to the transaction request before payment information corresponding to the transaction request is received from a first server corresponding to the transaction method. In operation 730, the electronic apparatus 110 transmits a shipping request for at least a portion of the at least one item to the second server 130 before the time section ends.

In operation 740, the electronic apparatus 110 transmits a payment request to the first server 120 in response to the time section ending.

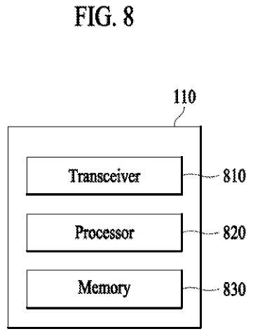

FIG. 8 is a diagram illustrating an example of a configuration of an electronic apparatus for processing item sales information according to an example embodiment.

Referring to FIG. 8, the electronic apparatus 110 includes a transceiver 810, a processor 820, and a memory 830. The electronic apparatus 110 is connected to the electronic device 120, the user terminal 210, the first server 120, the second server 130, the third server 410, the fourth server 420, and other external devices through the transceiver 810, and may exchange data.

The processor 820 may include at least one of the devices described above with reference to FIGS. 1 through 7, or may perform at least one method described above with reference to FIGS. 1 through 7. The memory 830 may store information (including at least some of transaction method information, transaction amount information, account information, information on a password for transaction, fingerprint information, facial information, transaction approval information, and payment information) for performing at least one method described above with reference to FIGS. 1 through 7. The memory 830 may be a volatile memory or a nonvolatile memory.

The processor 820 may execute a program and control the electronic apparatus 110 for providing information. The code of a program executed by the processor 820 may be stored in the memory 830.

In some cases, the electronic apparatus 110 may further include a UI for providing information to a user.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The electronic apparatus or terminal in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

1. A method operable for processing item sales information, the method comprising:
controlling, by a processor of an electronic apparatus, a transceiver of the electronic apparatus to communicate with a first server and a second server;
receiving, by the transceiver of the electronic apparatus, a transaction request for an item, the transaction request comprising a transaction method and transaction amount for the item, the transaction request being associated with a user;
determining, by the processor of the electronic apparatus, that the transaction method relates to a specific type of transaction method managed by the first server;
determining, by the processor of the electronic apparatus, a transaction receipt time at which the electronic apparatus received the transaction request;
determining, by the processor of the electronic apparatus, that the transaction receipt time falls within a predetermined time period of the transaction method, wherein the predetermined time period comprises a time in which a normal operation of the first server is restricted; and
in response to the determination that the transaction receipt time falls within the predetermined time period of the transaction method:
generating, by the processor of the electronic apparatus, a transaction response comprising approval information corresponding to the transaction request, wherein the transaction response is generated prior to the electronic apparatus receiving, from the first server, payment information regarding the transaction amount and corresponding to the transaction request;
transmitting, by the transceiver of the electronic apparatus, a shipping request for the item to the second server; and
transmitting, by the transceiver of the electronic apparatus, a payment request regarding the transaction amount to the first server after the predetermined time period of the transaction method has passed.

2. The method of claim 1, wherein the generating of the transaction response comprises:
determining that the item is to be delivered; and
in response to the determination that the item is to be delivered, providing the transaction response for the item.

3. The method of claim 1, further comprising:
determining that the item is a non-delivery item;
in response to the determination that the item is a non-delivery item, providing transaction denial information in response to the transaction request for the item,
wherein the transaction denial information comprises information on the predetermined time period of the transaction method.

4. The method of claim 1, wherein the transaction method corresponds to a transfer of a transaction amount based on an account managed by the first server, and
wherein the payment request corresponds to a request for the first server to transfer the transaction amount based on the account and transmit payment information comprising transfer details of the transaction amount to the electronic apparatus.

5. The method of claim 4, wherein information associated with the account managed by the first server is registered in the electronic apparatus in advance.

6. The method of claim 1, further comprising:
receiving payment failure information from the first server in response to the payment request;
canceling approval corresponding to the transaction request; and
transmitting a cancellation request for the shipping request to the second server.

7. The method of claim 1, further comprising:
receiving payment failure information from the first server in response to the payment request and an indication that shipping for at least a portion of the item has been completed; and
transmitting a turn-in request for a shipping-completed item to a third server.

8. The method of claim 1, further comprising:
receiving, from at least one server corresponding to at least one transaction method, at least one time period information corresponding to the at least one transaction method.

9. The method of claim 1, wherein the time period comprises a time for performing a system maintenance related to the first server, and
wherein the system maintenance is performed periodically.

10. The method of claim 1, further comprising:
receiving payment failure information from the first server in response to the payment request, wherein the payment failure information comprises information indicating that the predetermined time period has not ended yet; and
retransmitting the payment request to the first server.

11. The method of claim 1, further comprising:
receiving a transaction cancellation request for the item;
canceling approval corresponding to the transaction request; and
transmitting a cancellation request for the shipping request to the second server.

12. The method of claim 11, wherein the cancellation request for the shipping request is transmitted to the second server based on a time period for performing a shipping task corresponding to the shipping request.

13. The method of claim 11, further comprising: determining that the transaction cancellation request is received during the predetermined time period; and
cancelling an approval corresponding to the transaction request after the predetermined time period.

14. The method of claim 11, further comprising:
determining that the transaction cancellation request is received outside of the predetermined time period; and
transmitting a cancellation request for the payment request to the first server.

15. The method of claim 1, further comprising:
storing sales information on the item comprising identification information associated with the transaction method;
receiving payment failure information from the first server; and
canceling transaction for the sales information,
wherein the canceling of the transaction for the sale information comprises:
canceling approval corresponding to the transaction request; and
transmitting a cancellation request for the shipping request to the second server.

16. A non-transitory computer-readable recording medium storing thereon computer-readable instructions that, when executed by a processor of an electronic apparatus, cause the processor to:
control a transceiver of the electronic apparatus to communicate with a first server and a second server;
receive a transaction request for an item, the transaction request comprising a transaction method and transaction amount for the item, the transaction request being associated with a user;
determine that the transaction method relates to a specific type of transaction method managed by the first server;
determine a transaction receipt time at which the electronic apparatus received the transaction request;
determine that the transaction receipt time falls within a predetermined time period of the transaction method, wherein the predetermined time period comprises a time in which a normal operation of the first server is restricted; and
in response to the determination that the transaction receipt time falls within the predetermined time period of the transaction method:
generate a transaction response comprising approval information corresponding to the transaction request, wherein the transaction response is generated prior to the electronic apparatus receiving, from the first server, payment information regarding the transaction amount and corresponding to the transaction request;
cause the transceiver of the electronic apparatus to transmit a shipping request for the item to the second server; and
cause the transceiver of the electronic apparatus to transmit a payment request regarding the transaction amount to the first server after the predetermined time period of the transaction method has passed.

17. An electronic apparatus for processing item sales information, the electronic apparatus comprising:
a transceiver;
a memory in which instructions are stored; and
a processor,
wherein the processor is configured to:
control the transceiver to communicate with a first server and a second server;
receive a transaction request for an item, the transaction request comprising a transaction method and transaction amount information, the transaction request being associated with a user;
determine that the transaction method relates to a specific type of transaction method managed by the first server;
determine a transaction receipt time at which the electronic apparatus received the transaction request;
determine that the transaction receipt time falls within a predetermined time period of the transaction method, wherein the predetermined time period comprises a time in which a normal operation of the first server is restricted; and
in response to the determination that the transaction receipt time falls within the predetermined time period of the transaction method:
generate a transaction response comprising approval information corresponding to the transaction request, wherein the transaction response is generated prior to the electronic apparatus receiving, from the first server, payment information regarding the transaction amount and corresponding to the transaction request;
transmit a shipping request for the item to the second server; and
transmit a payment request to the first server after the predetermined time period of the transaction method has passed.
